(19) United States
(12) Patent Application Publication
(10) Pub. No.: US 2012/0137364 A1
(43) Pub. Date: May 31, 2012

(54) REMOTE ATTESTATION OF A MOBILE DEVICE

(75) Inventor: James BLAISDELL, Novato, CA (US)

(73) Assignee: Mocana Corporation, San Francisco, CA (US)

(21) Appl. No.: 13/336,322

(22) Filed: Dec. 23, 2011

Related U.S. Application Data
(63) Continuation-in-part of application No. 12/246,609, filed on Oct. 7, 2008.

(51) Int. Cl. G06F 21/00

(52) U.S. Cl. 726/22

(57) ABSTRACT

Secure services and hardware on a mobile device are disabled if it is detected that software in the untrusted domain, such as the operating system, has been hacked or tampered with. Mobile devices often have rich, unprotected operating systems which are vulnerable to hacking, especially from execution of one or more apps. These apps are separated from secure services on the device, such as e-wallet services, NFC functionality, camera, enterprise access, and the like, and the present invention ensures that tampering with code in the untrusted domain or operating system does not affect these and other secure services. If tampering in the untrusted space is detected, the secure services and possible hardware on the device are shutdown or disabled. The extent of this disablement may depend on various factors, such as use of the device, type of device, context in which device is used (e.g., military, enterprise).

### CROSS REFERENCE TO RELATED APPLICATIONS

This application is a continuation-in-part which claims priority under 35 U.S.C. §120 to U.S. patent application Ser. No. 12/246,609 filed Oct. 7, 2008, entitled “PREVENTING EXECUTION OF TAMPERED APPLICATION CODE IN A COMPUTER SYSTEM,” which is hereby incorporated by reference in its entirety.

### BACKGROUND OF THE INVENTION

1. Field of the Invention

The present invention relates to computers and computer network security. More specifically, it relates to ensuring that secure services on mobile devices are protected from hackers and malware when apps and other software execute in unprotected areas of the devices.

2. Description of the Related Art

As the number of mobile devices grows and their use becomes more widespread, security on such devices is becoming increasingly important. Smartphones and tablets are being used to perform more functions, such as making purchases, and the operating systems on the devices is becoming richer and sophisticated, which is also leading to their vulnerability to hackers. Rich operating systems, such as Android or iOS, have millions of lines of code and are not entirely secure or trusted. Hackers know where the weaknesses are and devise ways to root or attack the operating system which, in turn, can make more secure or trusted modules in the device do unwanted activities, for example, make unauthorized purchases using an electronic wallet (“eWallet”) type service among other activities.

There are protocols and systems in place for ensuring that secure modules in mobile devices, such as the secure operating system and secure services, are well protected. For example, the ARM Trust Zone model ensures that the near-field communications (NFC) chip in a phone or device cannot be cloned and that the private key in the NFC chip is entirely secure from hacking. However, the secure operating system, for example, may still take instructions from modules or code in the unsecure or un-trusted operating system, such as the browser, to do certain things. So, while the secure modules, services, and chips are themselves generally safe from hacking, there are still ways to send unauthorized (i.e., hacked) instructions to these modules without them being aware of it; that is, it is still possible to hack or root the device by exploiting vulnerabilities in the un-trusted and unsecured components and domains in the device.

### SUMMARY OF THE INVENTION

One aspect of the present invention describes a method of disabling a secure service on a mobile device when abnormal behavior is detected in an operating system of the device, the operating system being the untrusted space or domain on the device. In one embodiment, an app executes in an operating system or in another untrusted domain in the mobile device. Functions are monitored in the operating system on the device and abnormal or rooted behavior is detected in the operating system. An alert signal is transmitted to a secure attestation module. Secure services are then disabled on the device and the extent of the disabling depends on device type and degree of attack. In one embodiment the disabling is done by the attestation module to the device hardware.

In other embodiments, the monitoring is performed using a special code monitor that is in communication with the secure attestation module. An NFC chip and an electronic wallet service are disabled if it is detected that the electronic wallet service was used to make an unauthorized purchase. In one embodiment, the disabling is caused by an attestation module. The secure services on the mobile device, such as a smart phone, may be electronic wallet services, display, enterprise access, camera, and speaker.

### BRIEF DESCRIPTION OF THE DRAWINGS

References are made to the accompanying drawings, which form a part of the description and in which are shown, by way of illustration, specific embodiments of the present invention:

FIG. 1 is a logical block diagram of a computing device memory space showing relevant sections of memory in accordance with one embodiment;

FIG. 2 is a logical block diagram of a process of creating profiles for applications in accordance with one embodiment of the present invention;

FIG. 3 is a logical block diagram of data and programs for creating modified object code using a linker utility in accordance with one embodiment of the present invention;

FIG. 4A is a sequence diagram showing one embodiment of a stub implementation in accordance with one embodiment;

FIG. 4B is a sequence diagram similar to the one shown in FIG. 4A but showing a more secure implementation of the supervisor;

FIG. 5 shows one embodiment of the supervisor as including a supervisor stack and stack management software in accordance with one embodiment;

FIG. 6 is a flow diagram of a process of generating a profile for a function in accordance with one embodiment;

FIG. 7 is a flow diagram of a process of creating executable code from modified object code containing stubs in accordance with one embodiment;

FIG. 8 is a flow diagram of a supervisor process executing to implement the security features of the present invention in accordance with one embodiment;

FIG. 9 is a block diagram showing components and modules relevant to implementing remote and local attestation in a mobile device in accordance with one embodiment;

FIG. 10 is a flow diagram of a process for disabling or shutting off one or more services on a mobile device if it is determined that the device has been compromised in accordance with one embodiment; and

FIGS. 11A and 11B are diagrams of a computer system suitable for implementing embodiments of the present invention.

### DETAILED DESCRIPTION OF THE INVENTION

Example embodiments of an application security process and system according to the present invention are described. These examples and embodiments are provided solely to add context and aid in the understanding of the invention. Thus, it will be apparent to one skilled in the art that the present invention may be practiced without some or all of the specific details described herein. In other instances, well-known concepts have not been described in detail in order to avoid unnecessarily obscuring the present invention. Other applications and examples are possible, such that the following examples, illustrations, and contexts should not be taken as definitive or limiting either in scope or setting. Although these embodiments are described in sufficient detail to enable one skilled in the art to practice the invention, these examples, illustrations, and contexts are not limiting, and other embodiments may be used and changes may be made without departing from the spirit and scope of the invention.

Methods and systems for preventing applications from performing in harmful or unpredictable ways, and thereby causing damage to computing device are described in the various figures. During execution, applications may be modified by external entities or hackers to execute in ways that are harmful to the computing device. Such applications, typically user applications, can be modified, for example, to download malware, obtain and transmit confidential information, install key loggers, and perform various other undesirable or malicious functions. In short, application programs are vulnerable to being modified to execute in ways that they were not intended for. Thus, a discrepancy may arise between the intended behavior of an application or function and the actual behavior of the application or function. Although there are products to prevent tampering with applications and functions by unauthorized parties, these products may not always be effective. Moreover, such products cannot prevent authorized parties from maliciously tampering with applications and functions on a computing device. The figures below describe methods and systems for preventing applications and functions that have been modified from executing and potentially doing damage to the host computing device.

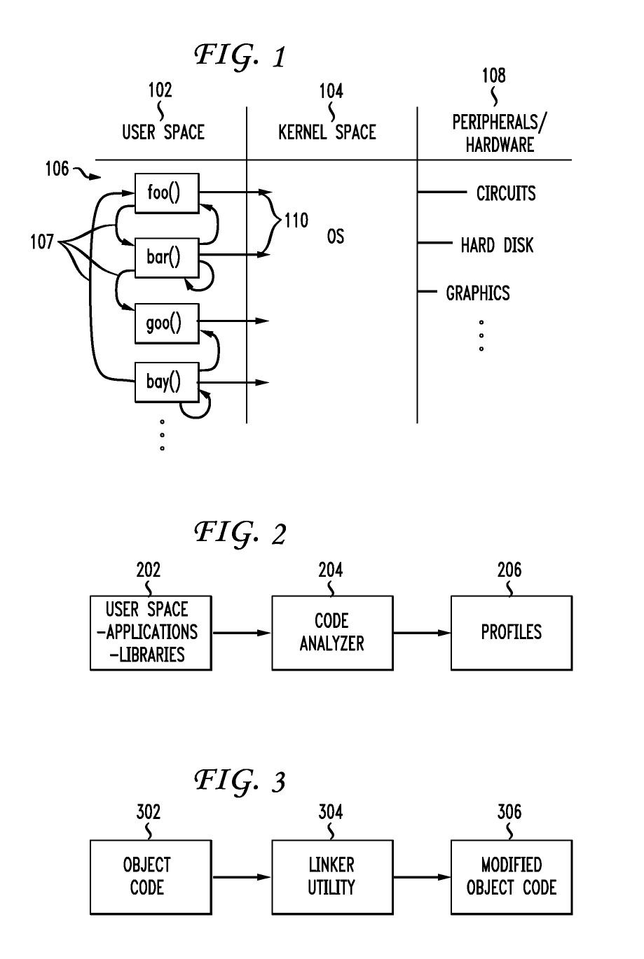

FIG. 1 is a logical block diagram of a memory space computing device. A modern computing device (hereinafter referred to as “computer”) using a modern operating system typically has storage area that may be divided into two areas: a user space 102 (where most of the applications and programs execute) and a kernel space 104 (or simply, kernel). An application or program (not shown) is essentially a series of calls to one or more functions 106. A function may be described as a logical set of computer instructions intended to carry out a particular operation, such as adding, writing, connecting to a circuit, and so on. Example functions foo( ) bar( ) goo( ) and baz( ) are shown in user space 102. When it is executed, a function always belongs to an application and does not exist independently of applications. As is known in the art, libraries become part of applications during the linking process, described below.

When an application executes, in most cases, a given function within the application may call other functions that are also within the same application. These calls are represented by arrows 107 in FIG. 1. Additionally, a function may also make, what is referred to, as a system call to kernel space 104. As is known in the art, devices and hardware 108 are typically accessed via kernel 104, which contains the operating system for the computer. In modern operating systems, kernel space 104, a secured area and strongly protected from external entities. Kernel 104 uses specific features of the CPU (e.g., Memory Management Unit, Supervisor Mode, etc.) to protect the kernel's own functions and data from being tampered with by code in user space 102. However, it should be noted that some computers may not have a seperate kernel space 104, for example, lightweight computing devices or handheld devices. A function in user space 102 may make system calls, represented by arrows 110 to kernel 104 when an application needs a service or data from kernel 104, including a service or utilization of a hardware component or peripheral.

As noted earlier, applications in user space 102 may be modified to do unintentional or harmful operations. When an application is first loaded onto the computer (or at any time thereafter) when the owner or administrator is confident that the application has not been tampered with, the application will execute in its intended and beneficial manner on the computer. That is, the application will do what it is supposed to do and not harm the computer. When an application has been tampered with, the tampering typically involves changing the series of function calls or system calls made within the application. A change in a single function call or system call may cause serious harm to the computer or create vulnerabilities. In one embodiment of the present invention, the intended execution of an application or, in other words, the list of functions related to the application, is mapped or described in what is referred to as a profile.

FIG. 2 is a logical block diagram of a process for creating profiles for applications in accordance with one embodiment of the present invention. Block 202 represents application code and libraries in user space 102. In one embodiment, block 202 represents all code in all the applications. In other embodiments, it may represent a portion of the code in some of the applications, but not necessarily all the applications. Similarly, in one embodiment, all the libraries (there may only be one) are analyzed and in other embodiments, only some of the libraries are included.

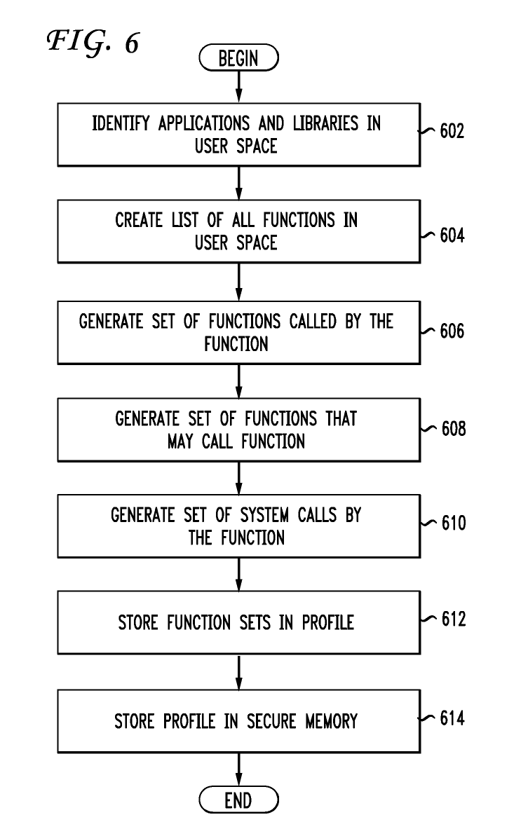

Block 204 represents a code analyzer of the present invention. Code analyzer 204 accepts as input application and library code contained in block 202. In one embodiment, code analyzer 204 examines the application and library code 202 and creates profiles represented by block 206. Operations of code analyzer 204 are described further in the flow diagram of FIG. 6. Briefly, code analyzer 204 creates a profile for each or some of the functions. Thus, functions foo( ) bar( ) goo( ) and so on, may each have one profile. A profile is a description of how a function is intended to operate; that is, how it should normally behave using sets of functions that the function may call and which functions may call it. In one embodiment, a profile is generated for each function. This process is described in greater detail below. As is known in the art, a function always operates in the context of a single application. That is, calls made to other functions by a function in one application do not change; the function will always make the same calls to other functions. Code analyzer 204 need only be run once or periodically, for example, when new applications or programs are added or deleted. Creating and storing profiles 206 may be seen as prerequisite steps for subsequent processes described below.

FIG. 3 is a logical block diagram of data and programs for creating modified object code using a linker utility in accordance with one embodiment of the present invention. As noted above, applications are comprised of functions which execute and may invoke or call other functions. Block 302 represents original object code of all or some of the applications after the applications (i.e., source code) have been compiled using conventional methods, namely, a suitable compiler depending on the source code language. Object code 302 (which may be object code for one, a subset, or all of the applications) is run through a linker utility program 304. Linker utility 304 examines each call made from one function to another and, in one embodiment, replaces the function being called with a replacement or substitute function, which may be referred to as a stub (indicated by the prefix x). This may be done for each function that is called at least once by another function. For example, if foo( ) calls bar( ) it will now call xbar( ).

As is known in the field, object code is typically run through a linker to obtain executable code. Block 306 represents “modified” object code which is the output of linker utility program 304. It is modified in the sense that functions that are being called are being replaced with a stub. In a normal scenario, a conventional linker program would have linked the object code to create normal executable code to implement the applications. However, in the present invention, linker utility 304 replaces certain functions with stubs and, therefore, creates modified object code. It is modified in that every function that calls bar( ) for example, now calls xbar( ). In one embodiment, functions that call bar( ) but are now calling xbar( ) in the modified object code, are not aware that they are now calling xbar( ). Furthermore, the original bar( ) is not aware that it is not getting calls from other functions from which it would normally get calls; that is, it does not know that it has been replaced by xbar( ). In one embodiment, the object file (containing the modified object code) also contains a “symbol table” that indicates which part of the modified object code corresponds to each function (similar to an index or a directory). Linker utility 304 adds new code (new CPU instructions), the stub (replacement function), and makes the “symbol table” entry for the function making a call point to the stub instead. In this manner, functions which want to call bar( ) will be calling xbar( ) instead. Xbar( ) has taken the identity of bar( ) in the “eyes” of all callers to bar( ). In one embodiment, the stub xbar( ) is a call to a supervisor which includes a supervisor stack and additional code to ensure that the environment does not look altered or changed in anyway.

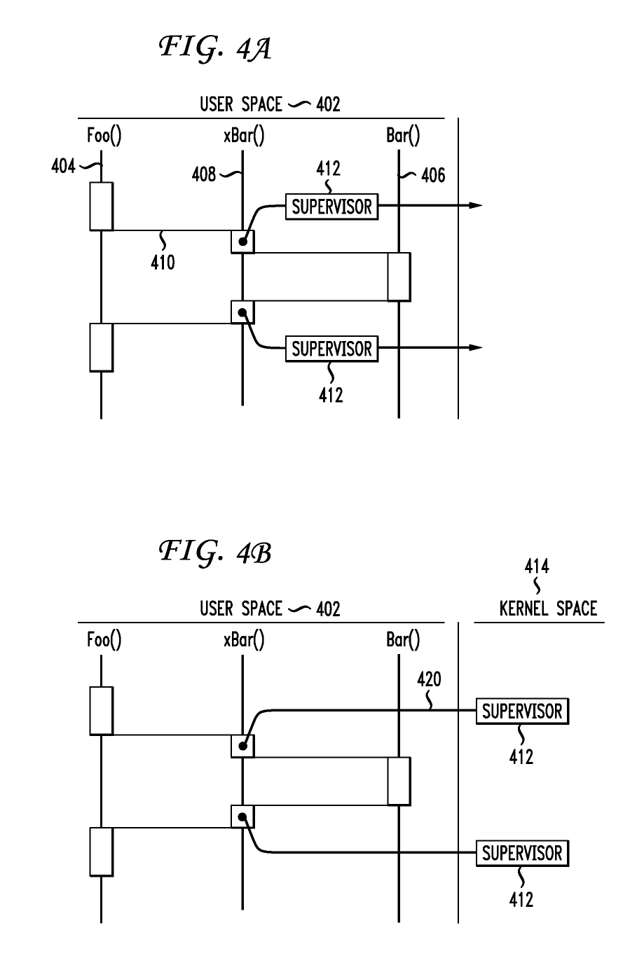

FIG. 4A is sequence diagram showing one embodiment of a stub implementation in accordance with one embodiment. A user space 402 has three time lines. A timeline 404 for foo( ) shows operation of the foo( ) function. A bar( ) timeline 406 shows operation of the bar( ) function. Inserted between foo( ) timeline 404 and bar( ) timeline 406 is an xbar( ) timeline 408 showing operation of the xbar( ) function. During operation of foo( ) a call is made to bar( ) shown by line 410. In one embodiment, the call is intercepted by xbar( ) time line 408. Xbar( ) invokes a supervisor 412, residing in user space 402. Supervisor 412 may make a system call if necessary.

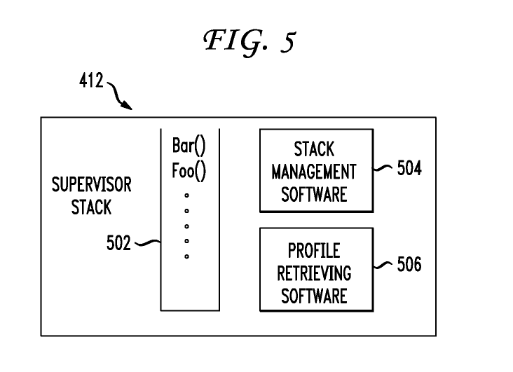

FIG. 5 shows one embodiment of supervisor 412 as including a supervisor stack 502 and stack management software 504. As part of management software 504, there may be software 506 for retrieving profiles. In one embodiment, profiles are stored with the application file itself. This may be preferred because the application file is generally a read-only file. Thus, the code and the profile are secure and cannot be edited, and the profile is also available automatically when the application file is read, so that the application can execute. In another embodiment, the profile is stored in a separate, read-only file. Referring again to FIG. 4, operations performed by supervisor 412 are described in greater detail in the flow diagrams below. Xbar( ) timeline 408 calls bar( ) timeline 406. Bar( ) executes and when it has completed, it returns the results to xbar( ) Bar( ) is unaware that it was called by xbar( ) and not by foo( ). Supervisor 412 is invoked again and examines the stack to ensure that foo( ) 404 called bar( ). Supervisor stack 502 may be used to check which functions are being called and which functions are making these calls. Xbar( ) time line 408 may then return the result to foo( ) time line 404.

FIG. 4B is a sequence diagram similar to the one shown in FIG. 4A but shows a more secure implementation of supervisor 412. In this implementation, supervisor 412 resides in kernel space 414. By keeping supervisor 412 in user space 402 in FIG. 4A, stack 502 may be vulnerable to manipulation. By storing supervisor 412 in kernel space 414, xbar( ) or any stub must make a system call to push or pop functions, onto or out of supervisor stack 502. As noted, system calls are the only way for user space applications to communicate with the kernel. This system call may be an entirely new one if the target operating system supports adding new system calls. By keeping the stack in kernel space 414, it may not be modified without making a system call. As described below, the new system call, represented by line 420, to supervisor 412 may be verified by checking its origin. For example, the call should not be originating from the original function code, such as code in function bar( ) but rather from code that is only in xbar( ). For example, the return address of the system call 420 performed by xbar( ) may be stored in a register (not shown) or in a stack, depending on the system call binary interface utilized by the target operating system. This return address may also be checked to ensure that it is located in a read-only code section of the application.

FIG. 6 is a flow diagram of a process of generating a profile for a function in an application in accordance with one embodiment. This process was described briefly in FIG. 2. A profile consists of sets or lists of functions and system calls. The “expected behavior” of a function is defined in a profile using these sets and lists. In one embodiment, this process of creating profiles for functions in an application is performed for a particular application prior to operation of the linker utility program and of other processes described below, none of which is operable without profiles for each or some of the functions. In one embodiment, the profile generation process may be performed by a service provider offering services to an entity (e.g., a company or enterprise) wanting to utilize the security measures described in the various embodiments. At step 602 applications and libraries are identified. The applications may include all the end-user applications and libraries needed to execute them. In one embodiment, at step 604, a list of all the functions in the user space is created. For each function, referred to as primary function herein, code analyzer is applied to the primary function to generate a list or set of functions that are called by the primary function. This may be done by the code analyzer analyzing the code of the primary function.

At step 608 the code analyzer generates the set of functions that may call the primary function. In one embodiment this is done by the code analyzer examining code in all the other functions (a complete set of these other functions was determined in step 602). At step 610 the code analyzer generates a set of system calls made by the primary function. As with step 606, the code analyzer examines the code in the primary function to determine which system calls are made. As described, a system call is a call to a function or program in the kernel space. For example, most calls to the operating system are system calls since they must go through the kernel space.

At step 612 the function sets generated at steps 606, 608, and 610 are stored in a profile that corresponds to the primary function. The function sets may be arranged or configured in a number of ways. One example of a format of a profile is shown below. At step 614 the profile is stored in a secure memory by the profiler program, such as in ROM, or any other read-only memory in the computing device that may not be manipulated by external parties. This process is repeated for all or some of the functions in the user space on the computing device. Once all the profiles have been created, the process is complete.

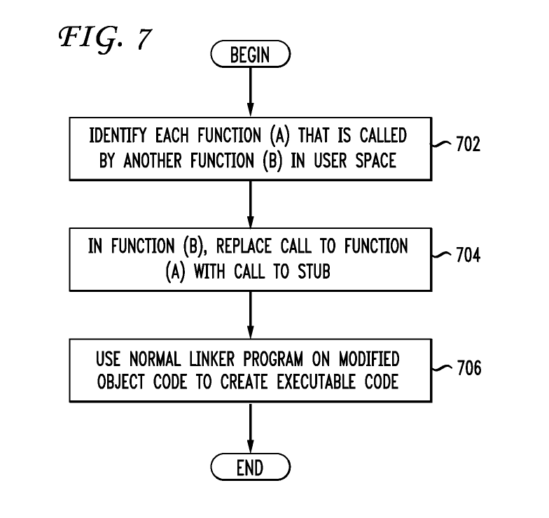

FIG. 7 is a flow diagram of a process of creating executable code from modified object code containing stubs in accordance with one embodiment. Before the security features of the present invention are implemented during normal execution of applications in the user space of the computing device, the executable code of each function that makes a call to another function is modified so that the call is made instead to a stub created by linker utility 304. At step 702 each function that is called by another function in the user space is identified. In a simple example, if foo( ) calls bar( ) and goo( ) calls foo( ) functions bar( ) and foo( ) are identified. The called functions are referred to as functions (A) and the calling functions (foo( ) and goo( )) as functions (B). At step 704 calls to functions (A) in functions (B) are replaced with calls to stubs corresponding to functions (A). Following the same example (and as described extensively above), if foo( ) originally calls bar( ) it now calls xbar( ) and goo( ) now calls xfoo( ). The functions foo( ) and bar( ) are unaffected and none of the functions are aware of the calls made to the stubs. In one embodiment, the substitution of the regular function call with the new call to the stub is made in the object code of functions (B) by linker utility program 304. At step 706 a conventional linker program is run on the modified object code to create the executable code, which now incorporates calls to the stubs. In one embodiment, this process is done for each application program in the user space, whereby all the relevant functions are modified. Once this process is complete, the process of creating executable code for the modified object code for each application is complete.

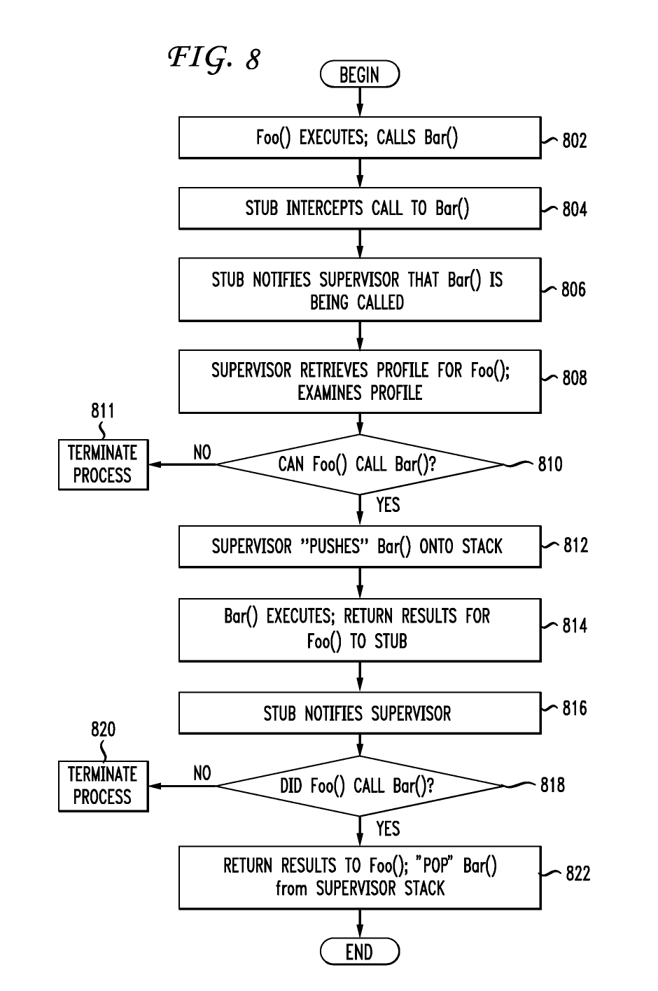

FIG. 8 is a flow diagram of a supervisor process for implementing the security features of the present invention in accordance with one embodiment. The processes described in FIGS. 6 and 7 are essentially prerequisite steps for implementing the process of FIG. 8. At step 802, an application is executing normally and a particular function, foo( ) executes. During execution of foo( ) another function, bar( ) is called by foo( ). At step 804, stub xbar( ) code that has been inserted as a substitute for bar( ) intercepts the call to bar( ). The function bar( ) (as well as other functions) has a unique identifier associated with it that is generated by code analyzer 204 for each function analyzer 204 profiles as described in FIG. 2. The stub contains this unique identifier. This identifier (part of the code) distinguishes the stub for bar( ) from other stubs.

At step 806 the stub xbar( ) notifies the supervisor that bar( ) is being called by foo( ). In one embodiment, the supervisor, including the supervisor stack and associated software, resides in the user space. In another embodiment, the supervisor resides in the kernel, in which case a system call is required by the stub. At step 808 the supervisor retrieves the profile for the calling function, foo( ) from secure memory, such as ROM. It then examines the profile and specifically checks for functions that may be called by foo( ). The profile may be stored in any suitable manner, such as a flat file, a database file, and the like. At step 810 the supervisor determines whether foo( ) is able or allowed to call bar( ) by examining the profile. If bar( ) is one of the functions that foo( ) calls at some point in its operation (as indicated accurately in the profile for fooO), control goes to step 812. If not, the supervisor may terminate the operation of foo( ) thereby terminating the application at step 811. Essentially, if bar( ) is not a function that foo( ) calls, as indicated in the profile for foo( ) (see FIG. 6 above), and foo( ) is now calling bar( ) something has been tampered with and suspect activity may be occurring.

At step 812 the supervisor pushes bar( ) onto the supervisor stack, which already contains foo( ). Thus, the stack now has bar( ) on top of foo( ). The stub is not placed on the supervisor stack; it is essentially not tracked by the system. At step 814 bar( ) executes in a normal manner and returns results, if any, originally intended for foo( ) to the stub, xbar( ). Upon execution of bar( ) the supervisor retrieves its profile. Calls made by bar( ) are checked against its profile by the supervisor to ensure that bar( ) is operating as expected. For example, if bar( ) makes a system call to write some data to the kernel, the supervisor will first check the profile to make sure that bar( ) is allowed to make such a system call. Functions called by bar( ) are placed on the supervisor stack.

Once the stub receives the results from bar( ) for foo( ) the stub notifies the supervisor at step 816 that it has received data from bar( ). At step 818 the supervisor does another check to ensure that foo( ) called bar( ) and that, essentially, foo( ) is expecting results from bar( ). It can do this by checking the stack, which will contain bar( ) above foo( ). If the supervisor determines that foo( ) never called bar( ) the fact that bar( ) has results for foo( ) raises concern and the process may be terminated at step 820. If it is determined that foo( ) did call bar( ) control goes to step 822 where the stub returns the results to foo( ) and the process is complete. The fact that xbar( ) is returning the results is not known to foo( ) and, generally, will not affect foo( )'s operation (as long as the results from bar( ) are legitimate). The function bar( ) is then popped from the supervisor stack. In one embodiment, bar( ) is popped from the stack, its results are sent to foo( ) (by xbar( )). If foo( ) keeps executing, it may remain in the stack, and the above process repeats for other functions called by foo( ).

Below is a sample format of a profile written in the C programming language.

Sample Profile Format

#define MOC_ID_CalledByFunc1ViaStatic (2)
#define MOC_ID_CalledByFunc2ViaNonStatic (3)
#define MOC_ID_CanBeStatic (4)
#define MOC_ID_Func1 (5)
#define MOC_ID_Func2 (6)
#ifndef _{——}XXXXXX_FUNCIDS_ONLY_{——}
extern const unsigned _MOC_calls_CanBeStatic[ ];
extern const unsigned _MOC_calls_Func1[ ];
extern const unsigned _MOC_calls_Func2[ ];
const unsigned const* const _XXXXXXX_db[14]
#ifdef _{——}GNUC_{——}
_{——}attribute_{——} ((section(“.nfp_db”),used))
#endif
= {
(const void*) 0, (const void*) 5, /* version, number of functions */
(const void*) 0xFFFFFFFF, (const void*) 0, /* no signal callback,
reserved */
0, 0, /* 2 CalledByFunc1ViaStatic */
0, 0, /* 3 CalledByFunc2ViaNonStatic */
_MOC_calls_CanBeStatic, 0, /* 4 CanBeStatic */
_MOC_calls_Func1, 0, /* 5 Func1 */
_MOC_calls_Func2, 0, /* 6 Func2 */
};
const unsigned _MOC_calls_CanBeStatic[ ]
#ifdef _{——}GNUC_{——}
_{——}attribute_{——} ((section(“.nfp_db”),used))
#endif
= {

1, /* size */
MOC_ID_CalledByFunc2ViaNonStatic,

};
const unsigned _MOC_calls_Func1[ ]
#ifdef _{——}GNUC_{——}
_{——}attribute_{——} ((section(“.nfp_db”),used))
#endif
= {

1, /* size */
MOC_ID_CalledByFunc1ViaStatic,

};
const unsigned _MOC_calls_Func2[ ]
#ifdef _{——}GNUC_{——}
_{——}attribute_{——} ((section(“.nfp_db”),used))
#endif
= {

1, /* size */
MOC_ID_CanBeStatic,

};
#endif
/* end of generated file */

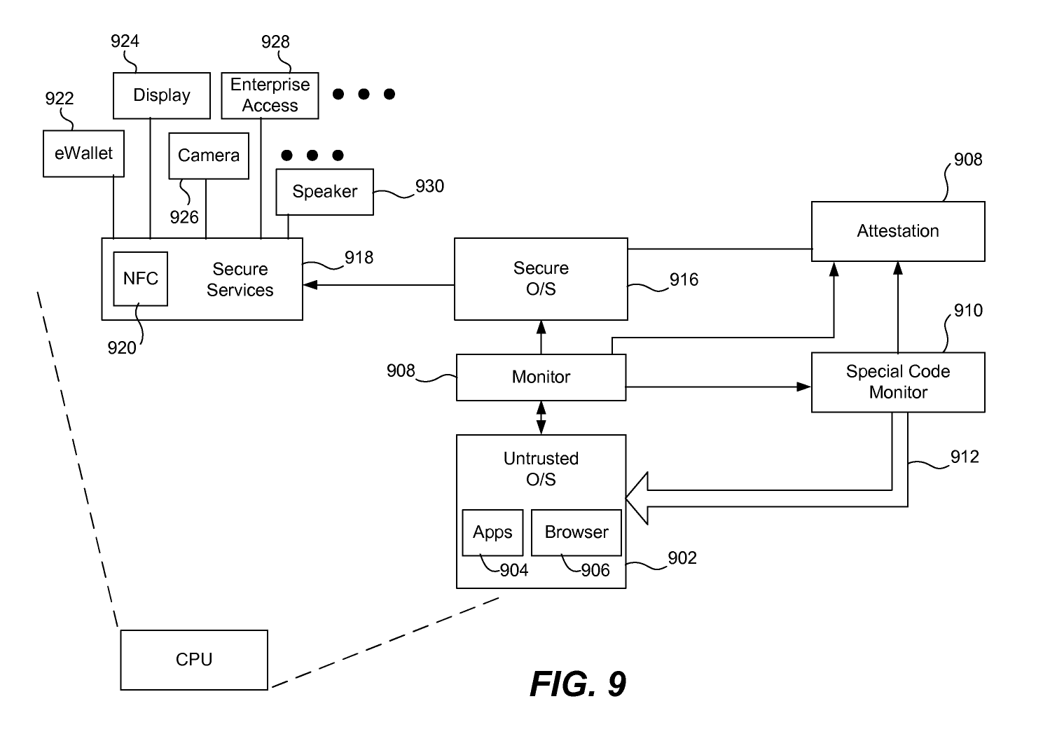

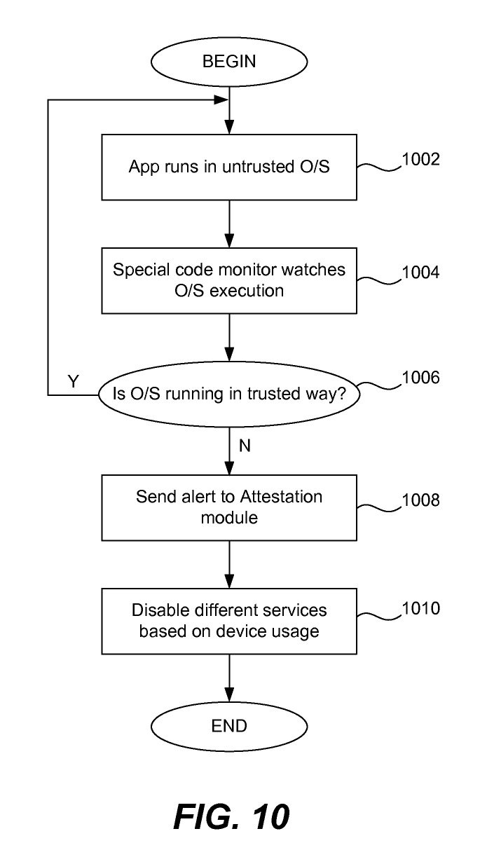

In other embodiments, methods and systems for causing the disablement or shutting down of secure services on a mobile device when an attack or unusual behavior is detected are described. These embodiments are described in FIGS. 9 and 10. As is known in the art, many mobile devices, especially smart phones and tablets, have very sophisticated, rich operating systems, often comprised of millions of lines of code. These operating systems have a growing array of services and functionality, making the smart phone or tablet more like a conventional PC. Users clearly enjoy the breadth and depth of this functionality from their handsets, but as the body of code grows, it becomes more unwieldy and vulnerable. There are more places on the surface of these rich operating systems through which hackers can enter and implant malware, modify code, delete data, insert timers so that code will change at a future date, and the like.

One way hackers can root an untrusted domain, specifically an operating system, is through apps. It is best to assume that all apps, whether those pre-installed on the device, or those downloaded from an app store, are not trustworthy (although generally the majority are good or safe apps but it is the few bad apps that can cause significant damage to a mobile device). Apps can be developed by hackers and appear safe or innocuous until they are downloaded and perform malware-type activities. For example, one app by itself may not be harmful but two apps by the same developer/hacker may operate together to root a mobile device. In another example, an app may be harmless when first downloaded but may have a timer that causes it to do harm to the device at a specific time in the future, thereby misleading the downloader/user as to the cause of any malfunctioning on the device.

Detecting whether a device has been rooted or jail broken is becoming increasingly important as mobile devices become widespread and users become more accustomed to downloading software and treating them as general computing devices for work and personal use. This is one motivation for the ARM Trust Zone model described above. This model is effective in preventing secure services, specifically the NFC chip and its private key from being cloned. However, it cannot protect a rich operating system from being modified or infiltrated. The rich operating system is part of an untrusted world in the mobile device ecosystem. It executes using the CPU. As described below, the NFC chip also talks or communicates directly with the CPU, for example, when making a purchase.

FIG. 9 is a block diagram showing components and modules relevant to implementing remote and local attestation in a mobile device in accordance with one embodiment. The rich, untrusted operating system is shown as module 902 and is comprised of various software components, such as apps 904, a browser 906, and operating system software. As noted, it is this software that continues to be vulnerable to hackers and malware insertion. Module 902 is in communication with a monitor module 908. In one embodiment, monitor 908 keeps track of input variables to and from operating system module 902, which is generally the conventional role of monitor 908.

A special software code monitor 910 watches untrusted operating system module 902. This watching or monitoring is represented by unidirectional line 912. Special monitor 910 ensures that module 902 is running in a trusted manner and that generally the execution of the untrusted world is normal and not subverted. This can be done using the methods and systems described above with respect to the code analyzer, profiles, and stubs. When special software monitor 910 detects that something is not behaving correctly in module 902, it sends an alert to an attestation module 914.

Special monitor 910 may also receive an alert from monitor 908 if the monitor detects a bad input variable. In another embodiment, monitor 908 may send an alert directly to attestation module 914 if there are bad inputs. In other embodiments, monitor 908 may send alerts to both special monitor 910 and to attestation module 914. Attestation module 914 is also a secure service and has a direct connection with a secure operating system module 916.

As described below, attestation module 914 ensures that the device is running in a safe manner or mode and is able to disable, cut off, or shut down services or the entire device, as needed, in a way that makes it difficult for a user or hacker to turn back on. As noted above, secure operating system 916 is often a small amount of code (e.g., 30 KB) and has a higher CPU authority/priority (untrusted operating system or domain has a lower CPU priority). Secure operating system 916 is in communication with or contains secure services 918. Secure services 918 may contain a near-field communications (NFC) chip 920 and various other services, such as eWallet 922, display 924, camera 926, enterprise access 928, speaker 930, and so on. All these services have a higher CPU priority. In one embodiment, communication among these components (902, 908, . . . ) is through an inter-process communication (IPC) gateway.

When special monitor 910 detects that something in the untrusted world has been subverted or rooted, it informs attestation module 914 via, in one embodiment, the IPC gateway. For example, if the user of the device attempts to connect to an enterprise (e.g., for the user's work), the enterprise will perform a remote attestation with the device first. If attestation module 914 has been alerted of abnormal behavior from special monitor 910, the attestation by the enterprise will fail.

FIG. 10 is a flow diagram of a process for disabling or shutting off one or more services on a mobile device if it is determined that the device has been compromised in accordance with one embodiment. At step 1002 apps run in the untrusted world, part of the rich operating system. As noted, the apps may be pre-installed on the device or the user may have downloaded them. In addition to apps, other types of software and services may execute in the operating system, such as a browser. Thus, at step 1002 the user is using the phone or tablet in a conventional, day-to-day manner. At the same time, at step 1004, the special monitor watches the operating system execution. It may also be monitoring other software and modules in the mobile device while it is doing this.

While watching the operating system at step 1004, the special monitor is inherently determining whether it is running in a trusted or normal way at step 1006. It can do this using the code analyzer, profiles, and other processes and techniques described above. Step 1006 may be described as taking place during step 1004. If the special monitor determines that the operating system is running in a normal manner, control essentially goes back to the beginning of the process and the device continues to function in a normal manner. If the code analyzer determines that the operating system is not operating in a trusted way, either from its direct observation of it or from being alerted by the monitor (i.e., detecting that inputs are potentially bad), then an alert is sent to the attestation module at step 1008 from the special monitor. In another embodiment, the monitor can send an alert directly to the attestation module. As noted, the attestation module is a secure service itself and generally cannot be hacked or compromised.

At step 1010 the attestation module causes the shut down or disablement of services. Which services are cut off may depend on several factors, such as the type of device, the extent of the attack, and the like. Based on how the device is being used, different functionality on the device can be crippled or disabled when device misbehavior is detected. For example, a military phone may have its microphone and speaker disabled, a consumer device may have the eWallet functionality, i.e., the NFC service, turned off, an enterprise or company device may have its private keys struck out to prevent access to corporate networks, and so on. In another embodiment, the operation is more binary and the device is generally shut down, i.e., few of the services are allowed to operate or the phone remains fully functional. In one embodiment, the modifications made by the attestation module are to the device hardware, which make it more difficult for the user to reset and begin using the phone or tablet. Given that once a device is rooted, there is very little if no trust in the device, especially if the device is used for work and is used to access enterprise systems. In some cases, the hardware is modified and locked, and thus cannot be reset by the user.

In other cases, only certain services may still be engaged, such as speaker, display, power, and the like. In this manner, if the unsecured operating system is somehow attacked, hacked, or modified in an unauthorized way, it cannot proceed to send instructions to the secure services, i.e., it cannot contaminate the secure world on the device with malware-sourced instructions. For example, if an eWallet app is used to make unauthorized purchases, the NFC chip and eWallet secure service on the device are immediately disabled (making it impossible to obtain the private key), possibly along with several other services and hardware on the phone, essentially making the phone unusable except for basic functions. In another example, if the phone attempts to connect to a network, such as a company or government enterprise, the enterprise will attest the security of the device by performing a remote attestation with the device. The attestation module will cause this remote attestation to fail because it has been alerted of abnormal behavior in the untrusted domain on the phone. After services (software) and hardware on the device are disabled or modified at step 1010, the process is complete.

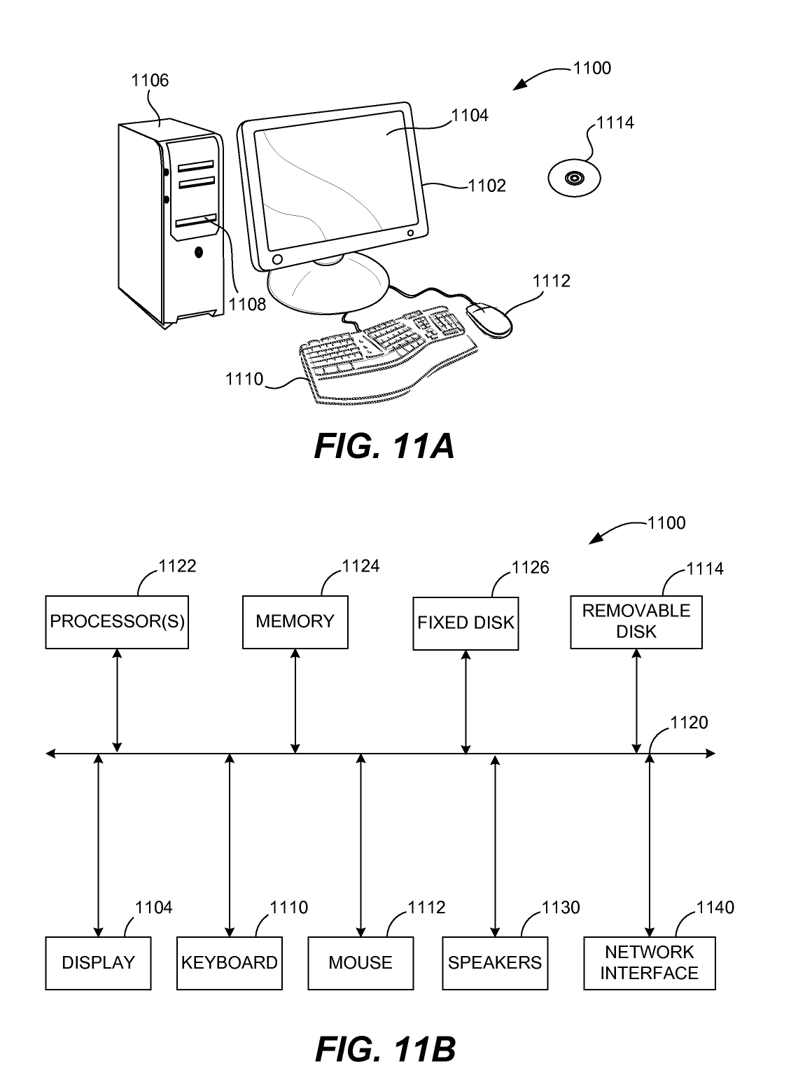

FIGS. 11A and 11B are diagrams of a computer system 1100 suitable for implementing embodiments of the present invention. FIG. 11A shows one possible physical form of a computer system or PC as described above. Of course, the computer system may have many physical forms including an integrated circuit, a printed circuit board, a small handheld device (such as a mobile telephone, handset or PDA), a personal computer, a server computer, a laptop or netbook computer, or a super computer. Computer system 1100 includes a monitor 1102, a display 1104, a housing 1106, a disk drive 1109, a keyboard 1110 and a mouse 1112. Disk 1114 is a computer-readable medium used to transfer data to and from computer system 1100.

FIG. 11B is an example of a block diagram for computer system 1100. Attached to system bus 1120 are a wide variety of subsystems. Processor(s) 1122 (also referred to as central processing units, or CPUs) are coupled to storage devices including memory 1124. Memory 1124 includes random access memory (RAM) and read-only memory (ROM). As is well known in the art, ROM acts to transfer data and instructions uni-directionally to the CPU and RAM is used typically to transfer data and instructions in a bi-directional manner. Both of these types of memories may include any suitable of the computer-readable media described below. A fixed disk 1126 is also coupled bi-directionally to CPU 1122; it provides additional data storage capacity and may also include any of the computer-readable media described below. Fixed disk 1126 may be used to store programs, data and the like and is typically a secondary storage medium (such as a hard disk) that is slower than primary storage. It will be appreciated that the information retained within fixed disk 1126, may, in appropriate cases, be incorporated in standard fashion as virtual memory in memory 1124. Removable disk 1114 may take the form of any of the computer-readable media described below.

CPU 1122 is also coupled to a variety of input/output devices such as display 1104, keyboard 1110, mouse 1112 and speakers 1130. In general, an input/output device may be any of: video displays, track balls, mice, keyboards, microphones, touch-sensitive displays, transducer card readers, magnetic or paper tape readers, tablets, styluses, voice or handwriting recognizers, biometrics readers, or other computers. CPU 1122 optionally may be coupled to another computer or telecommunications network using network interface 1140. With such a network interface, it is contemplated that the CPU might receive information from the network, or might output information to the network in the course of performing the above-described method steps. Furthermore, method embodiments of the present invention may execute solely upon CPU 1122 or may execute over a network such as the Internet in conjunction with a remote CPU that shares a portion of the processing.

In addition, embodiments of the present invention further relate to computer storage products with a computer-readable medium that have computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs and holographic devices; magneto-optical media such as floptical disks; and hardware devices that are specially configured to store and execute program code, such as application-specific integrated circuits (ASICs), programmable logic devices (PLDs) and ROM and RAM devices. Examples of computer code include machine code, such as produced by a compiler, and files containing higher-level code that are executed by a computer using an interpreter.

Although illustrative embodiments and applications of this invention are shown and described herein, many variations and modifications are possible which remain within the concept, scope, and spirit of the invention, and these variations would become clear to those of ordinary skill in the art after perusal of this application. Accordingly, the embodiments described are to be considered as illustrative and not restrictive, and the invention is not to be limited to the details given herein, but may be modified within the scope and equivalents of the appended claims.

What we claim:

1. A method of disabling a secure service on a mobile device when abnormal behavior is detected in an operating system of the device, the method comprising:
executing an app in an operating system;
monitoring functions performed in the operating system on the device;
detecting abnormal behavior in the operating system;
transmitting an alert signal to a secure attestation module; and
disabling secure services on the device, and wherein extent of said disabling depends on device type and degree of attack, and wherein disabling is done by the attestation module to the device hardware.

2. A method as recited in claim 1 wherein said monitoring is performed using a special code monitor that is in communication with the secure attestation module.

3. A method as recited in claim 1 further comprising:
disabling an NFC chip and an electronic wallet service if it is detected that the electronic wallet service was used to make an unauthorized purchase.

4. A method as recited in claim 1 wherein the operating system is untrusted.

5. A method as recited in claim 1 wherein said disabling is caused by an attestation module.

6. A method as recited in claim 1 wherein said disabling depends on how the device is being used.

7. A method as recited in claim 1 wherein instructions are blocked from being sent to a secure service if the operating system has been attacked.

8. A method as recited in claim 1 wherein secure services include electronic wallet services, display, enterprise access, camera, and speaker.

9. A mobile device comprising:
means for executing an app;
means for monitoring functions performed in the operating system on the device;
means for detecting abnormal behavior in the operating system;
means for transmitting an alert signal to a secure attestation module; and
means for disabling secure services on the device, wherein extent of disabling depends on device type and degree of attack, and wherein disabling is done by an attestation module, and wherein a secure service is disabled on a mobile device when abnormal behavior is detected in an operating system of the device.

10. A mobile device as recited in claim 9 wherein said means for monitoring includes a special code monitor that is in communication with the secure attestation module.

11. A mobile device as recited in claim 9 further comprising:
means for disabling an NFC chip and an electronic wallet service if it is detected that the electronic wallet service was used to make an unauthorized purchase.

12. A mobile device as recited in claim 9 wherein said means for disabling is caused by the secure attestation module.

13. A mobile device as recited in claim 9 wherein instructions are blocked from being sent to a secure service if the operating system has been attacked.

14. A mobile device as recited in claim 9 wherein secure services include electronic wallet services, display, enterprise access, camera, and speaker.
